(19) United States
(12) Patent Application Publication
(10) Pub. No.: US 2003/0189187 A1
(43) Pub. Date: Oct. 9, 2003

(54) Dissolved oxygen releasing compound

(76) Inventors: Robert Hollabaugh, Cocoa, FL (US); I. Richard Schaffner JR., Goffstown, NH (US)

Correspondence Address: Law Offices of William B. Ritchie, 43 Jackson Street, Concord, NH, 03301, US

(21) Appl. No.: 10/118,099

(22) Filed: Apr. 8, 2002

(51) Int. Cl. C09K 3/00; C01B 15/00; C01B 13/00; C01B 11/00; A01N 1/00; A62D 3/00; A62D 9/00; C01B 7/00

(52) U.S. Cl. 252/186.27; 252/186.43

(57) ABSTRACT

A dissolved oxygen releasing compound is disclosed utilizing magnesium peroxide blended with powdered Bentonite and/or vegetable oil. The Bentonite (or other clay material) reduces the hydraulic conductivity of magnesium peroxide, thereby reducing the rate of magnesium peroxide disassociation.

### FIELD OF THE INVENTION

This invention relates to the field of biological stimulants and, in particular, to such stimulants used in the attenuation of environmental contaminants.

### BACKGROUND OF THE INVENTION

Biological stimulants are often used to enhance the natural attenuation of environmental contaminants. Bioremediation products are commercially used to attenuate such contaminants as fuel hydrocarbon constituents and organic solvents that may be biologically transformed or immobilized under aerobic conditions. The dissolved oxygen released from such products transforms/immobilizes the contaminants.

For this reason, a slow dissolved oxygen release is preferred to increase contact with the contaminants dissolved in groundwater or adsorbed onto the formation matrix. A fast release is ineffective when trying to remove the contaminants. For example, magnesium/calcium peroxide is a potential stimulant for contaminant attenuation. However, upon hydration these peroxides tend to disassociate rapidly. In fact, magnesium/calcium peroxide can release their entire dissolved oxygen load within a few weeks of hydration. For optimum use, such stimulants must release dissolved oxygen slowly over a longer period of time, on the order of months and not weeks.

There are other compounds, such as MgO₂, that slowly release oxygen when chemically bonded with phosphate. This release of oxygen is a chemical process. Again, if the oxygen is released too fast, the compound is useless as a bioremediation product. While chemically-bonded products can solve the time-releasing problem, such compounds can be costly to manufacture and use in large amounts.

Therefore, what is needed is a compound to release dissolved oxygen that can be manufactured without using a chemical process. A compound for use as a bioremediation product that releases dissolved oxygen slowly over a long time frame is also needed. Such a compound that satisfies the time frame demands at a low cost is not commercial available.

### SUMMARY OF THE INVENTION

The present invention is a dissolved oxygen releasing compound (hereinafter abbreviated as DORC). The compound is a blend of magnesium peroxide and binding agents that are added to decrease the rate at which magnesium peroxide disassociates upon hydration to yield dissolved oxygen and magnesium cation. Magnesium peroxide, chemically similar to calcium peroxide, tends to disassociate rapidly upon hydration without the addition of binding agents or other engineered controls to slow the disassociation rate. Without such controls, the entire load of dissolved oxygen will be released within weeks of hydration. To be usable as a bioremediation product, the rate of disassociation of magnesium peroxide must be decreased, thereby increasing the time period of dissolved oxygen release.

In the present invention, Bentonite is used as an engineered control to reduce the disassociation rate. While Bentonite is specified, the invention specified herein includes other such phyllosilicate clay materials which may also be used to decrease the rate of dissolved oxygen release. Bentonite is mixed in a predetermined ratio by mass with magnesium peroxide. When this blend is hydrated, the release of dissolved oxygen continues at an acceptable rate for a time frame on the order of six months. An acceptable rate essentially means the rate of dissolved oxygen release over the time period are adequate to transform/immobilize the biological contaminants of concern.

The invention also contemplates alternate embodiments of the dissolved oxygen releasing compound. These include magnesium peroxide blended with powdered Bentonite and/or vegetable oil.

Therefore, it is an aspect of this invention to provide a dissolved oxygen releasing compound for use as a bioremediation product.

It is another aspect of the invention to provide a dissolved oxygen releasing compound comprising magnesium peroxide blended with Bentonite or other clay materials.

It is a further aspect of the invention to provide a compound to assist in the attenuation of environmental contaminants.

It is yet another aspect of the invention to provide a compound to release dissolved oxygen over an extended time frame.

These aspects of the invention are not meant to be exclusive and other features, aspects, and advantages of the present invention will be readily apparent to those of ordinary skill in the art when read in conjunction with the appended claims and accompanying description.

### DETAILED DESCRIPTION OF THE INVENTION

Magnesium peroxide disassociates upon hydration to yield dissolved oxygen and the cation magnesium (II). In order to slow the disassociation process, the magnesium peroxide is blended with a binding agent. The resulting dissolved oxygen releasing compound must be readily and inexpensively manufactured, and also release significant concentrations of dissolved oxygen over an extended period of time, on the order of six months or more.

The disassociation of magnesium peroxide to dissolved oxygen is primarily controlled by kinetic processes. Therefore, the binding agents used must slow the kinetics of magnesium peroxide disassociation. In the present invention, a powdered phyllosilicate is used as a binding agent to reduce the hydraulic conductivity of magnesium peroxide, thereby reducing the rate of dissolved oxygen release. In the preferred embodiment, the powdered phyllosilicate used is Bentonite.

A variety of blends of magnesium peroxide and powdered Bentonite were studied to determine the optimum blend for use as a bioremediation product. Specifically, three blends, one consisting of 50% by mass magnesium peroxide and 50% powdered bentonite, the second of 65% by mass magnesium peroxide and 35% powdered Bentonite, and the third 80% by mass magnesium peroxide and 20% powdered Bentonite, were considered.

To evaluate the potential effectiveness of these blends, a lab-scale microcosm study was performed as follows. The blends were suspended in injection socks 1-foot long and constructed of rip-stop nylon fabric. Three socks of each blend were inserted into a designed microcosm. Each microcosm consisted of 2-inch SCH 40 PVC riser pipe with an end cap including a flow meter. The flow meter was connected to a gas chamber including two fritted stone gas difflusers to sparge nitrogen gas through the water in that chamber. The gas diffusers were plumbed to a nitrogen gas source that ran continuously during the study at a flow rate sufficient to strip oxygen and maintain relatively low dissolved oxygen concentrations in column influent, about <1.0 mg/L. By stripping dissolved oxygen from column influent, any dissolved oxygen measured in column effluent above background may be attributed to the respective sock load. Microcosms were positioned so that column influent and effluent ports were at the top and bottom of each microcosm respectively. Water was circulated through the closed system at a rate of 40 ml/minute per each microcosm. The microcosm study was carried out until such time as respective dissolved oxygen loads were depleted, which occurred at about six months.

A commercially available Oxygen Releasing Compound (hereinafter abbreviated as ORC) manufactured by Regenesis Bioremediation Products, Inc., was subjected to the study described above (of equivalent mass to DORC) and was found to release dissolved oxygen on average about a rate of 2.1 mg/L over the study duration (6 months). The first blend of magnesium peroxide and powdered Bentonite (the 50%/50% blend) had an average concentration of 2.8 mg/L, the second blend (65%/35%) had about 3.7 mg/L and the third (80%/20%) about 3.3 mg/L. However, the mean monthly data showed the 50%/50% blend had low mean release rates for months 3 through 6, indicating the dissolved oxygen load of this blend were released too quickly. Additionally, the 65%/35% blend had high mean dissolved oxygen release for the first three months, indicating its magnesium peroxide will be spent quickly. The blend of 80% magnesium peroxide to 20% powdered Bentonite was thus a more optimum blend for use as a bioremediation product.

The microcosm study described above was also carried out using blends of magnesium peroxide and vegetable oil, or magnesium peroxide with vegetable oil and powdered Bentonite. The vegetable oil was added as a hydrophobic wetting envelope to temporarily isolate the magnesium peroxide from groundwater, thereby reducing the rate of disassociation. While vegetable oil might compete with organic contaminants for dissolved oxygen in aqueous settings, the relatively high pH yielded during magnesium peroxide disassociation should inhibit microbial utilization of the vegetable oil such that it would not stimulate indigenous bacteria to scavenge significant dissolved oxygen. Additionally, because the vegetable oil has nominal aqueous solubility, it is not mobile and cannot exert oxygen demand at a distance from where it is injected. In blends containing mixtures of powdered Bentonite and vegetable oil, the magnesium peroxide was first blended with the vegetable oil before the powdered Bentonite was added so that vegetable oil coated the magnesium peroxide and not the Bentonite.

Two blends of magnesium peroxide and vegetable oil were tested. The first included 17.4 pounds of magnesium peroxide per gallon of vegetable oil (17.4 lbs/GAL). The second was 17.4 lbs/GAL+29.6 lbs/GAL+41.7 lbs/GAL. While these ratios are specified, the invention includes other potential blend ratios of magnesium peroxide and vegetable oil that may slow the rates of dissolved oxygen release.

The study included three blends of magnesium peroxide, vegetable oil and powdered Bentonite. The first was 17.4 lbs/GAL+50% by mass magnesium peroxide and 50% Bentonite. The second was 17.4 lbs/GAL+80% by mass magnesium peroxide and 20% Bentonite. And the third blend included 7.4 lbs/GAL+29.6 lbs/GAL+41.7 lbs/GAL+80% by mass magnesium peroxide and 20% Bentonite.

Neither of the magnesium peroxide/vegetable oil blends showed a satisfactory average release rate over the six month study. However, certain blends including vegetable oil and powdered Bentonite showed an average release of 2.6 mg/L and 3.0 mg/L respectively. These two blends also showed monthly mean release values that indicated the dissolved oxygen load was not spent too quickly. Therefore, while the preferred embodiment of the invention is a blend of 80% by mass magnesium peroxide and 20% powdered Bentonite, the blend consisting of 17.4 lbs magnesium peroxide/GAL vegetable oil+50% by mass magnesium peroxide and 50% Bentonite and the blend of 7.4 lbs/GAL+29.6 lbs/GAL+41.7 lbs/GAL+80% by mass magnesium peroxide and 20% Bentonite are alternate embodiments. In all embodiments, it appears the magnesium peroxide had been spent after a six month period, with performance characteristics similar to ORC.

Although the present invention has been described with reference to certain preferred embodiments thereof, other versions are readily apparent to those of ordinary skill in the art. Therefore, the spirit and scope of the appended claims is not limited to the description of the preferred embodiments contained herein.

What is claimed is:

1. A dissolved oxygen releasing compound for the attenuation of biological contaminants comprising:
magnesium peroxide; and
a powdered phyllosilicate;
wherein said magnesium peroxide and said powdered phyllosilicate are blended together, and wherein said magnesium peroxide disassociates to dissolved oxygen at a slower rate than if said powdered phyllosilicate was absent from said compound.

2. The dissolved oxygen releasing compound of claim 1, wherein said compound further comprises approximately 80% magnesium peroxide by mass, and approximately 20% powdered phyllosilicate by mass.

3. The dissolved oxygen releasing compound of claim 2 wherein said powdered phyllosilicate is Bentonite.

4. A dissolved oxygen releasing compound for the attenuation of biological contaminants comprising:
magnesium peroxide; and
powdered Bentonite;
wherein said magnesium peroxide and said powdered Bentonite are blended together, and wherein said magnesium peroxide disassociates to dissolved oxygen at a slower rate than if said powdered Bentonite was absent from said compound.

5. The dissolved oxygen releasing compound of claim 4, wherein said compound further comprises approximately 80% magnesium peroxide by mass, and approximately 20% powdered Bentonite by mass.

6. A dissolved oxygen releasing compound for the attenuation of biological contaminants comprising:
magnesium peroxide;
powdered Bentonite; and vegetable oil
wherein said magnesium peroxide is coated by said vegetable oil and said powdered Bentonite is blended together with said magnesium peroxide, and wherein said magnesium peroxide disassociates to dissolved oxygen at a slower rate than if said powdered Bentonite and said vegetable oil were absent from said compound.

7. The dissolved oxygen releasing compound of claim 6, wherein said compound further comprises approximately 80% magnesium peroxide by mass, and approximately 20% powdered Bentonite by mass.

8. The dissolved oxygen releasing compound of claim 6, wherein said compound further comprises approximately 50% magnesium peroxide by mass, and approximately 50% powdered Bentonite by mass.

9. The dissolved oxygen releasing compound of claim 8, wherein said compound further comprises 17.4 pounds of said magnesium peroxide per gallon of said vegetable oil.
